(19) United States
(12) Patent Application Publication
(10) Pub. No.: US 2002/0181476 A1
(43) Pub. Date: Dec. 5, 2002

(54) Network infrastructure device for data traffic to and from mobile units

(76) Inventors: Michael J. Badamo, Rockville, MD (US); David G. Barger, Darnestown, MD (US); Tony M. Cantrell, Hagerstown, MD (US); Wayne McNinch, Monrovia, MD (US); Christopher C. Skiscim, Dickerson, MD (US); David M. Summers, Gaithersburg, MD (US); Peter Szydlo, Whistling Wind Way, MD (US)

Correspondence Address: MCGLEW & TUTTLE, PC, SCARBOROUGH STATION, SCARBOROUGH, NY, 10510, US

(21) Appl. No.: 09/811,204

(22) Filed: Mar. 17, 2001

(51) Int. Cl. H04L 12/28

(52) U.S. Cl. 370/401; 370/389; 370/352

(57) ABSTRACT

A network gateway device has a physical interface for connection to a medium. The device has an ingress processor system for ingress processing of all or part of packets received from the physical interface and for sending ingress processed packets for egress processing. The device has an egress processor system for receiving ingress processed packets and for egress processing of all or part of received packets for sending to physical interface. Interconnections are provided, including an interconnection between the ingress processor and the egress processor, including an interconnection between the ingress processor and the physical interface, and including an interconnection between the ingress processor and the physical interface. A packet queue is provided with packets awaiting transmission. The packet queue may be the exclusive buffer for packets between packets entering the device and packet transmission. The packets may exit the device at a rate of the line established at the physical interface. The ingress processing system processes packets including at least one or more of protocol translation, de-encapsulation, decryption, authentication, point-to-point protocol (PPP) termination and network address translation (NAT). The egress processing system processes packets including at least one or more of protocol translation, encapsulation, encryption, generation of authentication data, PPP generation and NAT.

### FIELD OF THE INVENTION

The present invention generally relates to the mobile Internet and more particularly relates to network infrastructure devices such as mobile Internet gateways that allow wireless data communication users to access content through the Internet protocol (IP). The invention also relates to a process by which users of the IP network (or users connected through the IP network) can communicate with users of wireless data communications devices.

### BACKGROUND OF THE INVENTION

In order for users of wireless data communications devices to access content on or through the IP, a gateway device is required that provides various access services and subscriber management. Such a gateway also provides a means by which users on the IP network (or connected through the IP network) can communicate with users of wireless data communications devices.

The architecture of such a device must adhere to and process the mobile protocols, be scalable and reliable, and be capable of flexibly providing protocol services to and from the IP network. Traffic arriving from, or destined for the IP Router Network (e.g. the Internet) can use a variety of IP-based protocols, sometimes in combination. The device should also be able to provide protocol services to the radio access network (RAN) and to the IP Network, scale to large numbers of users without significant degradation in performance and provide a highly reliable system.

Devices have been used that include line cards directly connected to a forwarding device connected to the bus and a control device connected to the bus. The forwarding device performers transmit, receive, buffering, encapsulation, de-encapsulation and filtering. In such arrangement the forwarding device performs all processes related to layer two tunnel traffic. All forwarding decisions, as to an ingress processing (including de-encapsulation, decryption, etc.), are made in one location. Given the dynamics of a system requiring access by multiple users and the possible transfer of large amounts of data, such a system must either limit the number of users, to avoid data processing bottlenecks, or the system must seek faster and faster processing with faster and higher volume buses.

### SUMMARY AND OBJECTS OF THE INVENTION

It is an object of the invention to provide a network device, particularly a gateway device with an ingress processor system for ingress processing of all or part of received packets which is at least partially separate from an egress processor system for receiving ingress processed packets and for egress processing of all or part of received packets whereby packet processing is efficiently handled.

It is another object of the invention to provide a network infrastructure device, particularly for handling traffic arriving from or destined to RAN users, including users of a data communications protocol [s] specific to mobile and RAN technology and for handling traffic arriving from, or destined to the IP router network (e.g. the Internet) in which the system architecture of the device provides protocol services to the RAN and the IP network and is able to scale to large numbers of users without processing or transfer bottlenecks, without significant degradation in performance while providing a highly reliable device.

Is a further object of the invention to provide a network gateway device for communications back and forth between RAN technology and IP network systems providing protocol services for handling traffic between the systems and for processing packets from line cards connected as part of the gateway device with ingress packet processing at least partially physically separate from egress packet processing.

According to the invention, a network gateway device is provided with a physical interface for connection to a medium. The device includes an ingress processor system for ingress processing of all or part of packets received from the physical interface and for sending ingress processed packets for egress processing. The device also includes an egress processor system for receiving ingress processed packets and for egress processing of all or part of received packets for sending to the physical interface. Interconnections are provided including an interconnection between the ingress processor system and the egress processor system, an interconnection between the ingress processor system and the physical interface and an interconnection between the egress processor system and the physical interface.

Advantageously, the device may have a single packet queue establishing a queue of packets awaiting transmission. The packet queue may be the exclusive buffer for packets between packets entering the device and packet transmission. The device allows packets to exit the device at a rate of the line established at the physical interface.

The ingress processing system processes packets including at least one or more of protocol translation, de-encapsulation, decryption, authentication, point-to-point protocol (PPP) termination and network address translation (NAT). The egress processing system processes packets including at least one or more of protocol translation, encapsulation, encryption, generation of authentication data, PPP generation and NAT.

The ingress and egress processor systems may advantageously respectively include a fast path processor subsystem processing packets at speeds greater than or equal to the rate at which they enter the device. The fast path processor system may provide protocol translation processing converting packets from one protocol to another protocol. Each of the ingress and egress processor system may also include a security processor subsystem for processing security packets requiring one or more of decryption and authentication, the processing occurring concurrently with fast path processor packet processing. The processor systems may also include a special care packet processor for additional packet processing concurrently with fast path processor packet processing. The special care packet processor preferably processes packets including one or more of network address translation (NAT) processing and NAT processing coupled with application layer processing (NAT-ALG). The processor systems may also include a control packet processor for additional packet processing concurrently with fast path processor packet processing, including processing packets signaling the start and end of data sessions, packets used to convey information to a particular protocol and packets dependent on interaction with external entities.

The physical interface may include one or more line cards. The ingress processor system may be provided as part of a service card. The egress processor system may be provided as part of the service card or as part of another service card. Such a card arrangement may be interconnected with a line card bus connected to the line card, a service card bus connected to at least one of the service card and the another service card and a switch fabric connecting the line card to at least one of the service card and the another service card. The switch fabric may be used to connect any one of the line cards to any one of the service cards, whereby any line card can send packet traffic to any service card and routing of packet traffic is configured one of statically and dynamically by the line card. The service card bus may include a static bus part for connection of one of the service cards through the switch fabric to one of the line cards and a dynamic bus for connecting a service card to another service card through the fabric card. This allows any service card to send packet traffic requiring ingress processing to any other service card for ingress processing and allowing any service card to send traffic requiring egress processing to any other service card for egress processing. With this the system can make use of unused capacity that may exist on other service cards.

According to another aspect of the invention, a gateway process is provided including receiving packets from a network via a physical interface connected to a medium. The process includes the ingress processing of packets with an ingress processing system. This processing includes one or more of protocol translation processing, de-encapsulation, decryption, authentication, point-to-point protocol (PPP) termination and network address translation (NAT). The packets are then transferred to an egress packet processing subsystem. The process also includes the egress processing of the packets with an egress processing system. The processing includes one or more of protocol translation, encapsulation, encryption, generation of authentication data, PPP generation and NAT processing.

The line cards can be for various media and protocols. The line cards may have one or multiple ports. One or more of the line cards may be a gigabit Ethernet module, an OC-12 module or modules for other media types such as a 155-Mbps ATM OC-3c Multimode Fiber (MMF) module, a 155-Mbps ATM OC-3c Single-Mode Fiber (SMF) module, a 45-Mbps ATM DS-3 module, a 10/100-Mbps Ethernet I/O module, a 45-Mbps Clear-Channel DS-3 I/O module, a 52-Mbps HSSI I/O module, a 45-Mbps Channelized DS-3 I/O module, a 1.544-Mbps Packet T1 I/O module and others.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1A is a schematic drawing of a system using the device according to the invention;

FIG. 1A is a schematic drawing of another system using the device according to the invention;

FIG. 2A is a diagram showing a processing method and system according to the invention;

FIG. 2B is a diagram showing further processing aspects of the processing method shown in FIG. 2A;

FIG. 3 is a diagram showing system components of an embodiment of the device according to the invention;

FIG. 4A is a schematic representation of ingress protocol stack implementation, enabling processing of packets to produce an end to end packet (i.e. tunnels are terminated, IPSec packets are decrypted);

FIG. 4B is a schematic representation of egress protocol stack implementation, enabling processing of packets including necessary encapsulation and encryption;

FIG. 5 is a diagram showing service card architecture according to an embodiment of the invention;

FIG. 6 is a diagram showing the peripheral component interconnect (PCI) data bus structure of a service card according to the embodiment of FIG. 5;

FIG. 7 is a diagram showing the common switch interface (CSIX) data bus structure of a service card according to the embodiment of FIG. 5;

FIG. 8 is a flow diagram showing a process according to the invention; and

FIG. 9 is a diagram showing single point of queuing features of the invention.

### DESCRIPTION OF THE PREFERRED EMBODIMENTS

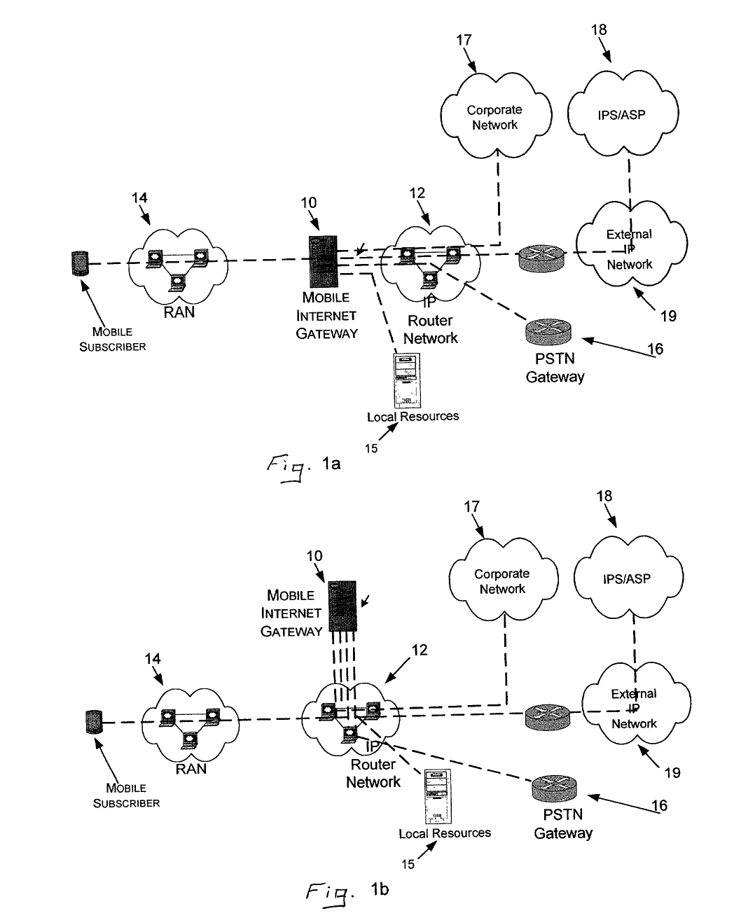

Referring to the drawings in particular, the invention comprises a network infrastructure device or mobile Internet gateway 10 as well as a method of communication using the gateway 10. FIGS. 1A and 1B depict two possible deployments of the invention. The invention can form a separation point between two or more networks, or belong to one or more networks. Gateway 10 handles data traffic to and from mobile subscribers via RAN 14. As shown in FIG. 1 data traffic arriving from, or destined to users on the RAN 14 must use one or more data communications protocols specific to mobile users and the RAN technology. Traffic arriving from, or destined for the IP Router Network (e.g. the Internet) 12 can use a variety of IP-based protocols, sometimes in combination. The architecture of the gateway 10 described here, the Packet Gateway Node (PGN) 10 solves the problem of being able to provide protocol services to the RAN 14 and to the IP Network 12, scale to large numbers of users without significant degradation in performance and provide a highly reliable system. It also provides for management of mobile subscribers (e.g., usage restrictions, policy enforcement) as well as tracking usage for purposes of billing and/or accounting.

The IP router network generally designated 12 may include connections to various different networks. The IP router network 12, for example, may include the Internet and may have connections to external Internet protocol networks 19 which in turn provide connection to Internet service provider/active server pages 18 or which may also provide a connection to a corporate network 17. The IP router network 12 may also provide connections to the public switched telephone network (PSTN) gateway 16 or for example local resources (data storage etc.) 15. The showing of FIGS. 1A and 1B is not meant to be all inclusive. Other networks and network connections of various different protocols may be provided. The PGN10 may provide communications between one or more of the networks or provide communications between users of the same network.

It is often the case that the amount of ingress processing differs from egress processing. For example, a request sent for Web content might be very small (with a small amount of ingress processing and a small amount of egress processing). However, the response might be extremely large (i.e., music file etc.). This may require a great deal of ingress processing and a great deal of egress processing. The serial handling of the ingress and egress processing for both the request and the response for a line card (for a particular physical interface connection) may cause problems such as delays. That is, when ingress and egress processing are performed serially, e.g., in the same processor or serially with multiple processors, traffic awaiting service can suffer unpredictable delays due to the asymmetric nature of the data flow.

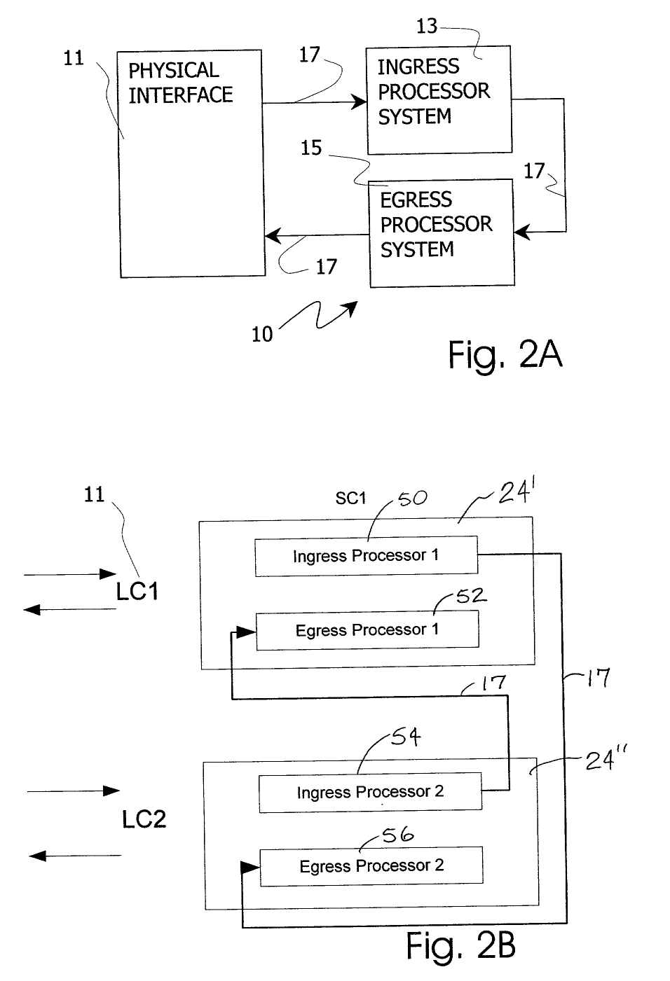

FIG. 2A shows an aspect of the PGN 10 and of the method of the invention whereby the ingress processing and egress processing are divided among different processing systems. Packets are received at the PGN 10 at physical interface 11 and packets are transmitted from the PGN 10 via the physical interface 11. The physical interface 11 may be provided as one or more line cards 22 as discussed below. An ingress processing system 13 is connected to the physical interface 11 via interconnections 17. The ingress processing system 13 preforms the ingress processing of received packets. This ingress processing of packets includes at least one or more of protocol translation, de-encapsulation, decryption, authentication, point-to-point protocol (PPP) termination and network address translation (NAT). An egress processing system 15 is connected to the physical interface 11 via interconnections 17 and is also connected to the ingress processing system 13 by interconnections 17. The egress processing system 13 preforms the ingress processing of received packets. This egress processing of packets includes at least one or more of protocol translation, encapsulation, encryption, generation of authentication data, PPP generation and NAT. The ingress processor 13 and egress processor 15 may be provided as part of a device integrated with the physical interface. Additionally, the ingress processor 13 and egress processor 15 may be provided as part of one or more service cards 24 connected to one or more line cards 22 via the interconnections 17. The processing method and arrangement allows ingress and egress processing to proceed concurrently.

As shown in FIG. 2B one service card 24′ may provide the ingress processing and another service card 24″ may provide the egress processing. The ingress processing or egress processing may be distributed between more than one service card 24. As shown in FIG. 2B a service card 24′ includes ingress processor system 50 and egress processor system 52. Packets are received from a line card LC1 designated 22′ and packets enter the ingress processor 50 where they are processed to produce end-to-end packets, i.e., tunnels (wherein the original IP packet header is encapsulated) are terminated, Internet protocol security (IPSec) packets are decrypted, Point-to-Point Protocol (PPP) is terminated and NAT or NAT-ALG is performed. The end-to-end packets are then sent to another service card 24″ via interconnections 17. At this other service card 24″ the egress processor system 56 encapsulates and encrypts the end-to-end packets and the packets are then sent to the LC2 designated 22″ for transmission into the network at interface 11.

Each of the processor systems 13 and 15 in the example of FIG. 2A and 50, 52, 54 and 56 in the example of FIG. 2B is preferably provided with purpose built processors. This allows the processing of special packets, security packets, control packets and simple protocol translation concurrently. This allows the PGN 10 to use a single point of queuing for the device. A packet queue establishes a queue of packets awaiting transmission. This packet queue is the exclusive buffer for packets between packets entering the device and packet transmission. The packets exit the device or complete processing at a rate of the line established at the physical interface (at the rate of the packet ingress). Each processor system preferably includes a fast path processor subsystem processing packets at speeds greater than or equal to the rate at which they enter the device. The fast path processor system provides protocol translation processing converting packets from one protocol to another protocol. Each processor preferably includes a security processor subsystem for processing security packets and preferably a control subsystem for control packets and a special care subsystem for special care packets. The processor subsystems process concurrently. The device allows context (information related to user traffic) to be virtually segregated from other context. Further, the use of multiple service cards allows context to be physically segregated, if this is required.

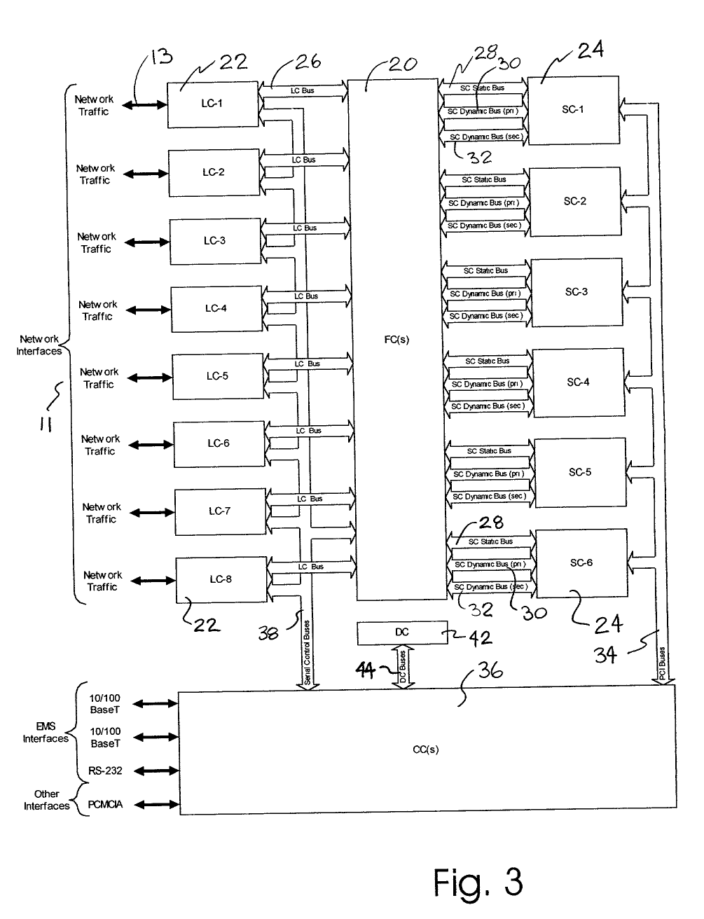

FIG. 3 shows a diagram of an embodiment of the hardware architecture. The system architecture of device 10 divides packet processing from traffic to and from the line cards (LCs) 22 via a switch fabric or fabric card (FC) 20. Processing is performed in service cards (SC) 24. The LCs 22 are each connected to the FC 20 via a LC bus 26 (static LC bus). The SCs 24 are connected by a SC static bus 28, SC dynamic bus (primary) 30 and SC dynamic bus (secondary) 32. A control card (CC) 36 is connected to LCs 24 via serial control bus 38. The CC 36 is connected to SCs 24 via PCI bus 34. A display card (DC) 42 may be connected to the CC 36 via DC buses 44. One or more redundant cards may be provided for any of the cards(modules) described herein (plural SCs, LCs, CCs, Fcs may be provided). Also, Multiple PCI buses may be provided for redundancy. The architecture of the PGN 10 allows all major component types, making up the device 10, to be identical. This allows for N+1 redundancy (N active components, 1 spare), or 1+1 redundancy (1 spare for each active component).

Several LCs 22 and several SCs 24 may be used as part of a single PGN 10. The number may vary depending upon the access need (types of connection and number of users) as well as in dependance upon the redundancy provided. The LCs 22 each provide a network interface 11 for network traffic 13. The LCs 22 handle all media access controller (MAC) and physical layer (Phy) functions for the system. The FC 20 handles inter-card routing of data packets. The SCs 24 each may implement forwarding path and protocol stacks.

The packets handled within the architecture are broadly categorized as fast path packets, special care packets, security packets and control packets. Fast path packets are those packets requiring protocol processing and protocol translation (converting from one protocol to another) at speeds greater than or equal to the rate at which they enter the device. Special care packets require additional processing in addition to the fast path packets. This might include Network Address Translation (NAT) or NAT coupled with application layer processing (NAT-ALG). Security packets require encryption, decryption authentication or the generation of authentication data. Control packets signal the start and end of data sessions, or are used to convey information to a particular protocol (i.e., the destination is unreachable). Control packets may also be dependent on interaction with external entities such as policy servers. The processing is divided according to the amount of processing required of the packet. The different classes of packet traffic are then dispatched to specialized processing elements so they may be processed concurrently. The concurrent nature of the processing allows for gains in throughput and speed not achievable by the usual serial processing approaches. In addition, all fast path processing is performed at a rate greater than or equal to that of the rate of ingress to the PGN 10. This eliminates the need for any queuing of packets until the point at which they are awaiting transmission. Thus the users of the device do not experience delays due to fast path protocol processing or protocol translation.

Packet manipulation with respect to tunnel termination, encryption, queuing and scheduling takes place on the SC 24. The master of the system is the CC 36. The CC 36 manages the system, and acts as the point of communication with other entities in the network, i.e. the policy servers and the accounting manager.

The flexible routing therefore enables any service card 24 or line card 22, in particular a spare service card 24 or line card 22, to assume the role of another service card 24 or line card 22 by only changing the routing through the switch fabric card (FC) 20. To support scalable performance, the PGN 10 divides the processing of in-bound protocols (e.g., the ingress path of LC1 22′ through ingress processor 50 as shown in FIG. 2B), the out-bound protocols (e.g., the egress path of LC2 22″ through egress processor 56 as shown in FIG. 2B) protocol control messaging, and the special handling of traffic requiring encryption.

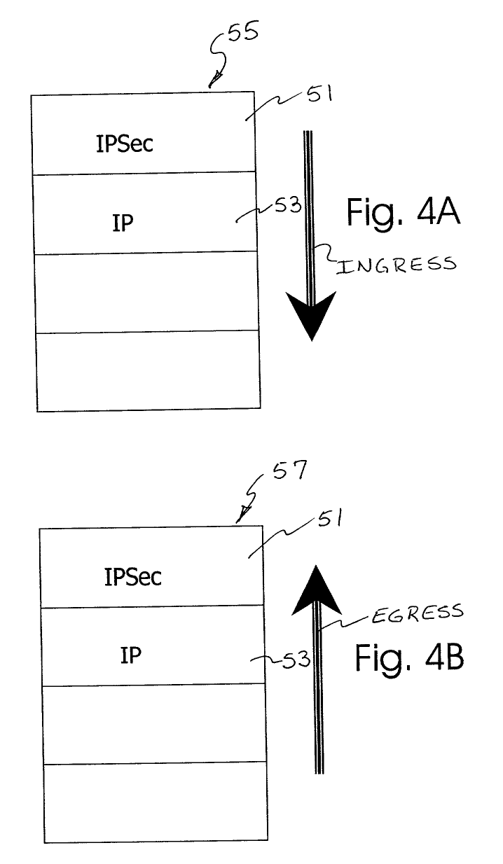

Various protocols may be implemented. The Internet protocol (IP) preferably is used at the network layer functioning above the physical/link layer (physical infrastructure, link protocols—PPP, Ethernet, etc.) and below the application layer (interface with user, transport protocols etc.). The device 10 can be used with the IPSec protocol for securing a stream of IP packets. In such a situation, where secure virtual private networks are established the PGN 10 will perform ingress processing including implementing protocol stacks 55 in a software process including deencapsulating and deencrypting on the ingress side and implementing protocol stack 57 including encapsulating and encrypting on the egress side. FIG. 4a illustrates this schematically with the ingress protocol stack 55 implementation being shown with processing proceeding from the IP layer 53 to the IP security layer 51. This can involve for example deencapsulating and decrypting, protocol translating, authenticating, PPP terminating and NAT with the output being end-to-end packets. FIG. 4b schematically illustrates the egress side protocol stack 57 implementation, wherein the end-to-end packets may be encapsulated, encrypted protocol translated, with authentication data generation, PPP generation and NAT. The IPSec encapsulation and/or encryption is shown moving from the IP security layer 51 to the IP layer 53.

Any line card 22 can send traffic to any service card 24. This routing can be configured statically or can be determined dynamically by the line card 22. Any service card 24 can send traffic requiring ingress processing (e.g. from SC1 24′ to SC2 24″) to any other service card 24 for ingress processing. Line cards 22 with the capability to classify ingress traffic can thus make use of unused capacity on the ingress service cards 24 by changing the routing.

Ingress processing 50 is physically separate from egress processing 56 (and also separate from processing at 52 and 54). This enables ingress processing to proceed concurrently with egress processing resulting in a performance gain over a serialized approach. Any service card 24 handling ingress processing (e.g., at 50) can send traffic to any other service card 24 for egress processing (e.g., at 56). Thus, the device can make use of unused capacity that may exist on other service cards 24.

The line cards (LC-x) 22 handle the physical interfaces. The line cards 22 are connected via the bus 38 to the (redundant) switch fabric card(s) (FC). Line card 22s may be provided as two types, intelligent and non-intelligent. An intelligent line card 22 can perform packet classification (up to Layer 3, network layer) whereas the non-intelligent line cards 22 cannot. In the former case, classified packets can be routed, via the FC 20, to any service card 24 (SC) where ingress and egress processing occurs. This allows for load balancing since the LC 22 can route to the SC 24 with the least loaded ingress processor. In the latter case, the assignment of LCs 22 to SCs 24 is static, but programmable. Redundancy management is also made easier: In the event of failure of a line card 22, a standby spare can be switched in by re-directing the flow through the FC 20.

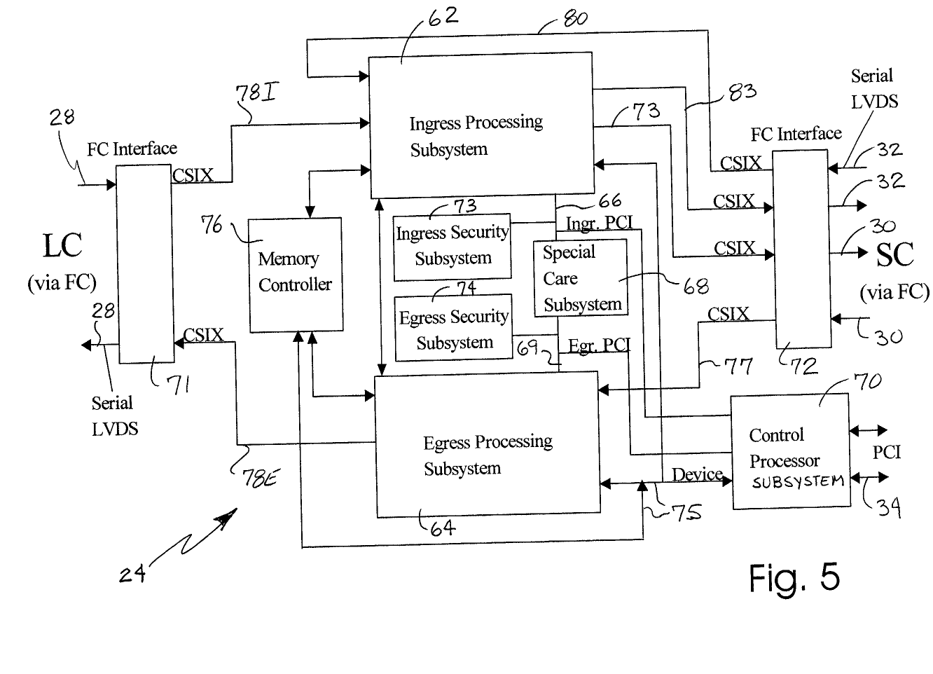

FIG. 5 shows the arrangement of service cards 24 (SC-x). Each SC 24 provides ingress processing with ingress processing subsystem 62 (for fast path processing) and egress processing with physically separate egress processing subsystem 64 (for fast processing). The processing functions of these subsystems 62 and 64 are separate. Each ingress processing system contains separate paths 66 for special processing and separate components 68, 70 and 73 for special processing. Each egress processing system contains a separate path 69 for special processing and the separate components 68, 70 and 74 for special processing.

The role of the service cards, such as SC 24′, is to process IP packets. IP packets enter the SC 24′ through the FC interface 20; this is traffic coming, e.g., from LC1 22′.

Packets enter the ingress processor system 50, where they are classified as subscriber data or control data packets. Control packets are sent up to one of two microprocessors, the control processor 70 or the special care processor 68. Protocol stacks (e.g., 55 or 57), implemented in software, process the packets at the control processor 70 or the special care processor 68. A subscriber data packet is processed by the ingress processing subsystem 62 and or security subsystem 73 to produce an end-to-end packet (i.e. tunnels are terminated, IPSec packets are decrypted). The end-to-end packet is sent to another SC 24″ via the FC 20. Packets enter the SC 24″ through the interface 72 to the FC 20. The packets enter the egress processor system. This may be by use of another service card (e.g., SC 24″) where all the necessary encapsulation and encryption is performed. The packet is next sent to, e.g., LC2 22″ that must transmit the packet into the network. Protocol stacks running on the control and special care processors may also inject a packet into the egress processor for transmission.

The flexible routing of ingress-to-egress, ingress-to-ingress (dividing ingress processing over more than one service card 24) and egress-to-egress allows the device to dynamically adapt to changing network loads as sessions are established and torn down. Processing resources for ingress and egress can be allocated on different service cards 24 for a given subscriber's traffic to balance the processing load, thus providing a mechanism to maintain high levels of throughput. Typically, a subscriber data session is established on a given SC 24 for ingress and the same, or another SC 24 for egress. Information associated with this session, its context, is maintained or persists on the ingress and egress processor (e.g., of the processing subsystems 62 and 64). The routing of ingress to ingress (e.g., from SC 24′ to SC 24″ via bus 32, FC 20, FC interface 72 and CSIX link 80) permits the traffic to enter via a different LC 22 (because of the nature of the mobile user, such user could have moved and may now be coming in via a different path) and be handled by the ingress processing subsystem SC 24 holding the context (e.g., by Ingress processing subsystem 62 of SC 24′). This eliminates the need to move the context at the price of maintaining context location. For example, the context information may be held and controlled by memory controller 76. Moving context data can be problematic.

Processing subscriber data packets on the SC 24 occurs in one of three modes, fast path, security and special care path. Fast path processing is aptly named because it includes any processing of packets through the SC 24 at a rate greater than or equal to the ingress rate of the packets. These processing functions are implemented in the ingress processing subsystem 62 and egress processing subsystem 64 using custom-built hardware. Packets that require processing that cannot be done in the fast path are shunted off on the path 66 or 69 for either special care processing with processor 68 or security processing with processor 73 or 74. Special care processing includes packets requiring PPP and GTP re-ordering or packets requiring NAT-ALG. Security processing is performed for IPSec packets or packets requiring IPSec treatment. When special care and security processing is completed, these packets are injected back into the fast path. Thus, while special care or security processing is in progress, the flow of packets not requiring such processing can proceed at a rate greater than or equal to their rate of the ingress. This method of concurrent processing eliminates the need to queue fast path packets thus enabling the device to sustain high and consistent levels of throughput.

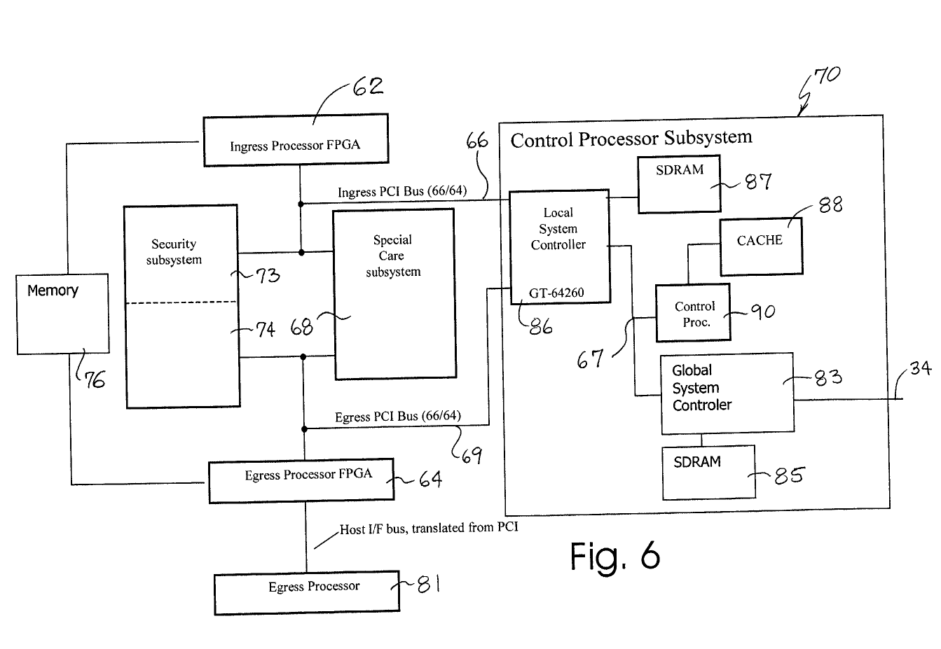

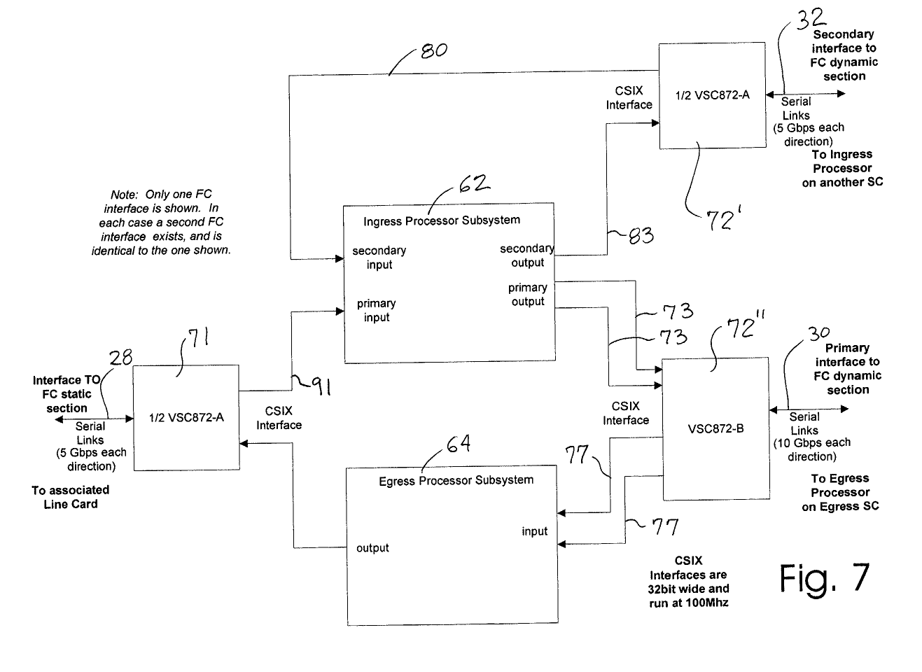

The internal interfaces of PGN 10 enable the connections amongst ingress and egress processing functions. The ingress and egress PCI buses 66 and 69 are the central data plane interfaces from the control plane to the data plane. The ingress PCI bus 66 (see FIG. 6) provides a connection between the ingress processor field programable gate array (FPGA) 62, encryption subsystem or security subsystem 73, special care processor subsystem 68 and control processor subsystem 70. The control processor subsystem 70 includes local system controller 86, synchronous dynamic random access memory (SDRAM) 87, cache 88, global system controller 83 (providing a connection to PCI bus 34), SDRAM 85 and control processor 90. The global system controller 83, the control processor 90 and the local system controller 86 are connected together via a bus connection 67. The egress PCI bus 69 connects egress processor FPGA 81, encryption subsystem or security subsystem 74, special care processor 68 and control processor system 70.

Each of the ingress PCI bus 66 and egress PCI bus 69 have an aggregate bandwidth of approximately 4Gb/s. They are used to pass data packets to and from the fast path hardware. For this reason, the egress processor FPGA 62 is the controller on the egress PCI bus 69, and the ingress processor FPGA 64 (connected to egress processor 81) is the controller on the ingress PCI bus 66. These PCI buses 66 and 69 are shared with the control plane. Control plane functions on the PCI bus 34 are discussed below.

The special care subsystem 68, the control processor system 70 and the security with switch fabric interface part (e.g., VSC872) 71. Bus 91 carries data from the line card 22′ via bus 28 and via the FC 20. The ingress processor subsystem 62 has a set of two (2) 3.2 Gb/s primary outputs with CSIX busses 77 with switch fabric interface part (e.g., VSC872) 72″ that will carry end to end data packets to the switch fabric (dynamic section) 20 for egress processing on the egress service card 24″. The connected service card (e.g., SC 24″) is packet dependent. The ingress processing element 62 has a secondary output in addition. This 3.2Gb/s bi-directional CSIX link 80/83 with switch fabric interface part (VSC872) 72′ to the switch fabric 20 is for ingress processor system 50 (e.g., of one SC 24′) to ingress processor 56 (cross service card, e.g., to another service card 24″) packet transfers.

The egress processing subsystem 64 receives data at inputs from two 3.2Gb/s CSIX links 77 out of the switch fabric interface part (e.g., VSC872) 72″. Packets coming to the egress processor subsystem 64 on these links have already been processed down to the end-to-end packet. The egress processor (e.g., 52 or 56) sends a completely processed packet out to the line card 22 via a 3.2Gb/s CSIX link 95 to the switch fabric interface part 71. The packet traverses the static switch fabric 20 on its way to the line card 22.

The LC static buses 26, and SC static buses 28, interconnect line cards 22 and service cards 24 through the fabric card 20. These connections are established when the control card configures the fabric card 20. Connections made between LCs 22 and SCs 24 may be made to be virtually static. The connections may rarely change. Some reasons for connection changes are protection switchover and re-provisioning of hardware.

Each of the static buses 26 and 28 is comprised of 4 high-speed unidirectional differential pairs. Two pairs support subscriber data in the ingress direction while the other two pairs support subscriber data in the egress direction. Each differential pair is a 2.64384 Gbps high-speed LVDS channel. Each channel contains both clock and data information and is encoded to aid in clock recovery at the receiver. At this channel rate the information rate is 2.5 Gbps. Since unidirectional subscriber data flows in 2 channels, or pairs, between LCs 22 and SCs 24 for each static bus 26 and 28, the aggregate information rate is 5 Gbps per direction per bus.

The primary dynamic buses 30 connect the ingress processor of one service card 24 to the egress processor of another service card 24 via the fabric card 20 on a frame-by-frame basis. Each primary dynamic bus 30 is comprised of 8 high-speed unidirectional differential pairs. Four pairs support subscriber data in the ingress direction while the other four pairs support subscriber data in the egress direction. Each differential pair is an 2.64384 Gbps high-speed LVDS channel. Each channel contains both clock and data information and is encoded to aid in clock recovery at the receiver. At this channel rate the information rate is 2.5 Gbps. Since unidirectional subscriber data flows in 4 channels, or pairs, the aggregate information rate for a given direction is 10 Gbps. Secondary dynamic buses 32 are electrically identical to the static buses but since they are dynamic, subscriber data may be rerouted on a frame-by-frame basis.

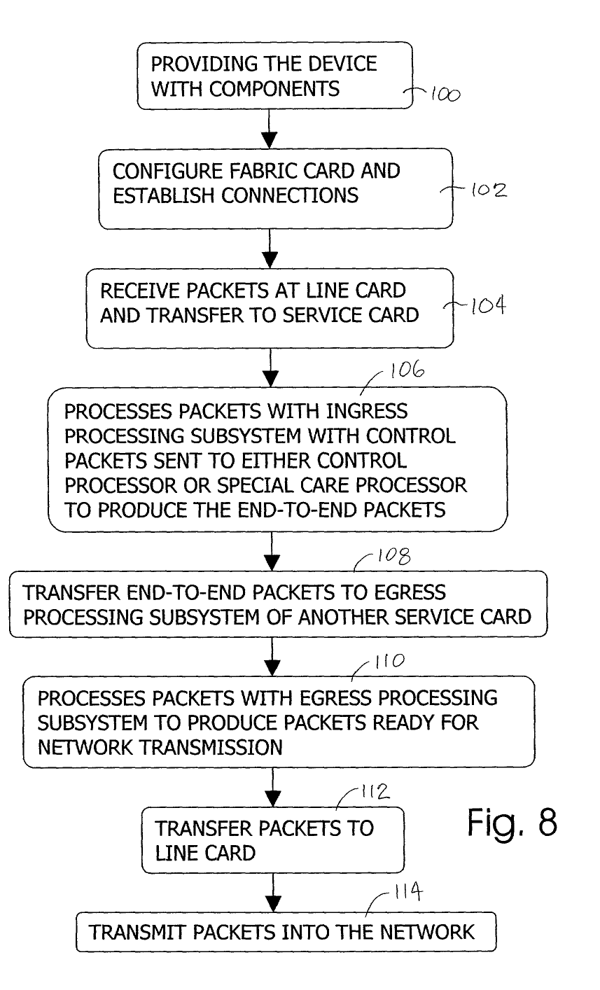

The process of the invention is illustrated generally in the flow diagram of FIG. 8. The process begins at 100 by providing the device infrastructure in the form of connection buses 28, 30 and 32 and providing a switch fabric 20 for selectively interconnecting the connection buses. At least a first line card 22′, second line card 22″, a first service card 24′, a second service card 24″, and a control card 36 are provided. Advantageously a redundant line card 22, redundant service card 24, a redundant fabric card 20 and a redundant control card 36 may be provided. The fabric card 20 or fabric cards 20 are connected and configured to establish a substantially static connection from first line card 22′ via line card bus 26 through fabric card 20 to service card static bus 28 to service card 1 designated 24′. In this configuration, the fabric card 20, as indicated at 102, also provides a connection from line card 22 designated 22″, the associated line card bus 26, the fabric card 20 and the service card static bus 28 associated with service card 2 designated 24″. Step 104 shows the further steps of receiving packets at the first line card 22′ transferring the packets via LC bus 26, fabric card 20, SC static bus 28 to the first service card 24′. As can be appreciated from FIG. 5, the first service card 24′ processes packets with ingress processing system 50. As indicated above, control packets are sent to either control processor 62 or special care processor 66 and subscriber data packets are processed to produce the end-to-end packets as shown at 106. At step 106 the necessary de-encapsulation and decryption are performed. As shown at 108, the end-to-end packets are transferred via FC20 to the egress processing system 56 of the second service card 24″ via dynamic bus 30 (primary dynamic bus). At step 110 the egress packet processor of second service card 24″ processes the end-to-end packets including encapsulation and encryption. The packets are then sent to a line card, such as second line card 22″ as indicated at step 112. The line card then transmits packets into the network as shown at 114. The protocol stack 55 running on the control processor 62 and special care subsystem 66 may also inject a packet into the ingress processor for transmission. The control processor 62 of service card 24″ and the special care processor 66 of service card 24″ may also treat further packets for egress processing

The entire system may be monitored using a display card 42 via display buses 44. The line cards may be monitored via serial control buses 38. The control card 36 may have other output interfaces such as EMS interfaces 48 which can include any one or several of 10/100 base T outputs 43 and serial output 47 and a PCMCIA (or compact flash) output 49.

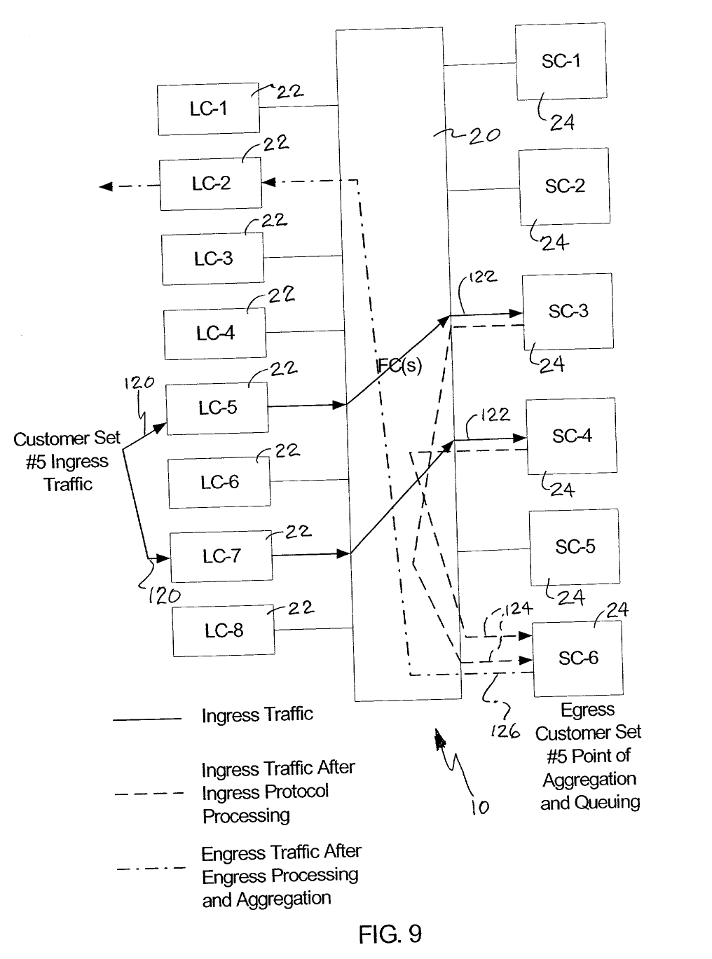

To support quality of service for multiple sets of customers, the device 10 supports a single point of queuing. Typically, a customer set 120, each set 120 comprising multiple individuals, will be assured of a certain set of protocol services and a portion of the total bandwidth available within the device. It is therefore necessary to be able to monitor the rate of egress of the customer set's traffic. FIG. 9 shows multiple customer sets 120 entering the device using different physical interfaces 22.

Because of the distributed nature of the physical ingress, in particular because members of a customer set 120 may ingress on any physical interface and because all processing is performed at a rate greater than or equal to the ingress rate, a common point of aggregation is established on the egress portion of the SC. Referring to FIG. 9, customer set #5 can enter the device using LC-5 and LC-7. The ingress protocol processing for this customer set #5 is hosted on SC-3 and SC-4 as indicated by ingress traffic 122 while egress processing is hosted on SC-6 as shown by traffic after ingrees protocol processing 124. The FC switches the ingress traffic from LC-5 and LC-7 to the two SCs 3 and 4 for ingress protocol processing. Since egress processing is hosted on SC-6, the FC 20 switches this traffic 124 to SC-6 for egress processing following ingress protocol processing. SC-6 provides the common point of aggregation and contains one or more queues (at the single location) for holding a customer set's traffic awaiting egress 126 to the LC. Queuing is necessary as the ingress rate of the customer set's aggregated traffic may, at times, exceed the egress rate of a particular physical interface. Monitoring of the egress rate of the customer set's traffic then occurs at the point of aggregation.

The invention provides a device based on modular units. The term card is used to denote such a modular unit. The modules may be added and subtracted and combined with identical redundant modules. However, the principals of this invention may be practiced with a single unit (without modules) or with features of modules described herein combined with other features in different functional groups.

While specific embodiments of the invention have been shown and described in detail to illustrate the application of the principles of the invention, it will be understood that the invention may be embodied otherwise without departing from such principles.

What is claimed is:

1. A network gateway device, comprising:
a physical interface for connection to a medium;
an ingress processor system for ingress processing of all or part of packets received from said physical interface and for sending ingress processed packets for egress processing;
an egress processor system for receiving ingress processed packets and for egress processing of all or part of received packets for sending to the physical interface;
interconnections including an interconnection between said ingress processor system and said egress processor system, an interconnection between said ingress processor system and said physical interface and an interconnection between said egress processor system and said physical interface.

2. A network gateway device according to claim 1, further comprising a packet queue establishing a queue of packets location awaiting transmission, said packet queue being the exclusive buffer location for packets between packets entering the device and packet transmission.

3. A network gateway device according to claim 1, wherein packets exit the device at a rate of the line established at the physical interface.

4. A network gateway device according to claim 1, wherein said ingress processing system processes packets including at least one or more of protocol translation, de-encapsulation, decryption, authentication, point-to-point protocol (PPP) termination and network address translation (NAT) and said egress processing system processes packets including at least one or more of protocol translation, encapsulation, encryption, generation of authentication data, PPP generation and NAT.

5. A network gateway device according to claim 1, wherein said ingress processor system includes a fast path processor subsystem processing packets at speeds greater than or equal to the rate at which they enter the device.

6. A network gateway device according to claim 5, wherein said fast path processor system provides protocol translation processing converting packets from one protocol to another protocol.

7. A network gateway device according to claim 5, wherein said egress processor system includes a fast path processor subsystem processing packets at speeds greater than or equal to the rate at which they are to leave the device.

8. A network device according to claim 5, wherein said ingress processor system includes a security processor subsystem for processing security packets requiring one or more of decryption and authentication, said processing occurring concurrently with fast path processor packet processing.

9. A network device according to claim 7, wherein said egress processor system includes a security processor subsystem for processing security packets requiring one or more of encryption and generation of authentication data, said processing occurring concurrently with fast path processor packet processing.

10. A network device according to claim 7, wherein said ingress processor system includes a special care packet processor for additional packet processing concurrently with fast path processor packet processing, said special care packet processor processing packets including one or more of network address translation (NAT) processing and NAT processing coupled with application layer processing (NAT-ALG).

11. A network device according to claim 7, wherein said ingress processor system includes a control packet processor for additional packet processing concurrently with fast path processor packet processing, including processing packets signaling the start and end of data sessions, packets used to convey information to a particular protocol and packets dependent on interaction with external entities.

12. A network device according to claim 1, wherein said physical interface includes a line card and said ingress processor system is provided as part of a service card and said egress processor system is provided in one of said service card and another service card and said interconnections include:
a line card bus connected to said line card;
a service card bus connected to at least one of said service card and said another service card; and
a switch fabric connecting said line card to at least one of said service card and said another service card.

13. A network device according to claim 12, wherein said service card includes said ingress processor system and said egress processor system and said another service card includes another ingress processor system for processing all or part of packets received from said line card and for sending ingress processed packets for egress processing and another egress processor system for receiving ingress processed packets and for processing all or part of received packets for sending to said line card, whereby packets may be sent between service cards for ingress processing by one service card and egress processing by another service card or for ingress processing using more than one service card.

14. A network gateway device according to claim 13, wherein each of said service cards is identical and a spare service cards is provided, for functionally replacing any one of the other service cards to provide redundancy.

15. A network gateway device according to claim 13, wherein said physical interface includes another line card connected by said switch fabric to at least one of said service card and said another service card.

16. A network gateway device according to claim 15, wherein said switch fabric connects any one of said line cards to any one of said service cards, whereby any line card can send packet traffic to any service card and routing of packet traffic is configured one of statically and dynamically by the said line card.

17. A network gateway device according to claim 13, wherein:
said service card bus includes a static bus part for connection of one of said service cards through said switch fabric to one of said line cards and a dynamic bus for connecting a service card to another service card through said fabric card allowing any service card to send packet traffic requiring ingress processing to any other service card for ingress processing and allowing any service card to send traffic requiring egress processing to any other service card for egress processing, whereby the system can make use of unused capacity that may exist on other service cards.

18. A network gateway device, comprising:
a plurality of line cards having a physical interface for connection to a medium and;
a plurality of service cards, each service card including an ingress processor for processing all or part of data received from one of said line cards and for sending ingress processed packets for egress processing and each of said service cards including an egress processor for receiving ingress processed packets and for processing all or part of received packets for sending to one of said line cards;
a line card bus connected to each of said line cards;
a service card bus connected to each of said service cards; and
a switch fabric connecting individual line cards to individual service cards, whereby packets may be sent between service cards for ingress processing by one service card and ingress processing by another service card or for shared ingress processing between more than one service card.

19. A network gateway device, comprising:
a first line card;
a first service card for packet processing including a first ingress processing system for at least one or more of de-encapsulation and decryption and a first egress processing system for at least one or more of encapsulation and encryption;
a second line card;
a second service card for packet processing including a second ingress processing system for at least one or more of de-encapsulation and decryption and a second egress processing system for at least one or more of encapsulation and encryption;
a switch fabric and connection interfaces connecting at least said first line card to said first service card, connecting said second line card to said second service card and connecting said first service card to said second service card.

20. A network system according to claim 19, wherein:
said connection interfaces include a static bus part for connection of one of said service cards through said switch fabric to one of said line cards and a dynamic bus for connecting a service card to another service card through said fabric card allowing any service card to send packet traffic requiring ingress processing to any other service card for ingress processing and allowing any service card to send traffic requiring egress processing to any other service card for egress processing, whereby the system can make use of unused capacity that may exist on other service cards.

21. A network system according to claim 19, wherein: each of said first ingress processing subsystem, said first egress processing subsystem, said second ingress processing subsystem and said second egress processing subsystem include physically separate packet processing.

22. A network gateway device according to claim 19, wherein each of said service cards is identical and a spare service cards is provided, for functionally replacing any one of the other service cards to provide redundancy.

23. A network gateway device according to claim 19, wherein said switch fabric connects any one of said line cards to any one of said service cards, whereby any line card can send packet traffic to any service card and routing of packet traffic is configured one of statically and dynamically to establish virtual traffic segregation for segregating traffic using one or more common service card and line card and to establish physical traffic segregation wherein traffic is segregated using groups of one or more service card and one or more line card.

24. A network gateway device according to claim 19, wherein said switch fabric connects any one of said line cards to any one of said service cards, whereby any line card can send packet traffic to any service card and routing of packet traffic is configured one of statically and dynamically by said line card.

25. A network gateway process, comprising:
receiving packets from a network via a physical interface connected to a medium;
ingress processing of packets, with an ingress processing system, including one or more of protocol translation processing, de-encapsulation, decryption, authentication, point-to-point protocol (PPP) termination and network address translation (NAT);
transferring packets to an egress packet processing subsystem;
egress processing said packets, with the egress processing system, including one or more of protocol translation, encapsulation, encryption, generation of authentication data, PPP generation and NAT processing.

26. A process according to claim 25, further comprising:
establishing a queue of packets awaiting transmission; and
transmitting queued packets via the physical interface, said packet queue being the exclusive buffer for packets between packets entering the ingress processing system and packet transmission.

27. A process according to claim 25, wherein packets are processed by said ingress processor at a rate of ingress at the physical interface.

28. A process according to claim 25, wherein said ingress processor system includes a fast path processor subsystem processing packets at speeds greater than or equal to the rate at which packets enter the ingress processor system.

29. A process according to claim 28, wherein said fast path processor system provides protocol translation processing converting packets from one protocol to another protocol.

30. A process according to claim 28, wherein said ingress processor system includes a security processor subsystem for processing security packets requiring one or more of decryption and authentication, said processing occurring concurrently with fast path processor packet processing.

31. A process according to claim 28, wherein said ingress processor system includes a special care packet processor for additional packet processing concurrently with fast path processor packet processing, said special care packet processor processing packets including one or more of network address translation (NAT) processing and NAT processing coupled with application layer processing (NAT-ALG).

32. A process according to claim 28, wherein said ingress processor system includes a control packet processor for additional packet processing concurrently with fast path processor packet processing, including processing packets signaling the start and end of data sessions, packets used to convey information to a particular protocol and packets dependent on interaction with external entities.

33. A process according to claim 28, further comprising:
providing said physical interface including a line card;
providing said ingress processor system as part of a service card;
providing said egress processor system is provided in one of the service card and another service,
providing a line card bus connected to the line card;
providing a service card bus connected to at least one of the service card and the another service card; and
providing a switch fabric connecting the line card to at least one of the service card and the another service card.

34. A process according to claim 25, further comprising:
providing said ingress processor system and said egress processor system as part of said service card;
providing another service card with another ingress processor system for processing all or part of packets received from said line card and for sending ingress processed packets for egress processing and another egress processor system for receiving ingress processed packets and for processing all or part of received packets for sending to the line card;
sending packets between service cards for ingress processing by one service card and egress processing by another service card or for ingress processing using more than one service card.

35. A process according to claim 33, further comprising:
providing another line card as part of said physical interface;
connecting said another line card, via said switch fabric to at least one of said service card and said another service card.

36. A process according to claim 35, further comprising:
using said switch fabric to connect any one of said line cards to any one of said service cards, whereby any line card can send packet traffic to any service card and routing of packet traffic is configured one of statically and dynamically by the said line card.

37. A process according to claim 33, further comprising:
providing said service card bus as a static bus for connection of one of said service cards through said switch fabric to one of said line cards and a dynamic bus for connecting a service card to another service card through said fabric card allowing any service card to send packet traffic requiring ingress processing to any other service card for ingress processing and allowing any service card to send traffic requiring egress processing to any other service card for egress processing, whereby the system can make use of unused capacity that may exist on other service cards.

38. A network gateway process according to claim 25, further comprising:
receiving packets from a network with a first packet protocol as part of said step of receiving packets;
using a first module ingress processing subsystem for said step of ingress processing of packets to produce end-to-end packets;
transferring the end-to-end packets to a second module egress packet processing subsystem;
using a second module egress processing subsystem for egress packet processing to produce packets for sending to a network with a second packet protocol;
receiving packets from the network with the second packet protocol;
using a second module ingress processing subsystem for ingress processing to produce end-to-end packets;
transferring the end-to-end packets to a first module egress processing subsystem;
using the first module egress packet processing subsystem for egress packet processing to produce packets for sending to the network with the first packet protocol.

39. The process according to claim 35, wherein
the first module is a service card for packet processing with the ingress processing subsystem separate from the egress processing subsystem and the second module is a service card for packet processing with the ingress processing subsystem separate from the egress processing subsystem.

40. The process according to claim 38, further comprising:
providing a switch fabric;
connecting a first line card to the switch fabric via a bus, the first line card providing a network interface;
connecting the first service card to the switch fabric via a bus;
connecting a second line card to the switch fabric via a bus, the second line card providing a network interface with the first packet protocol;
connecting the second service card to the switch fabric via a bus;
transferring packets from the first line card to the first service card via the fabric card and connected busses;
transferring packets from the first service card to the second service card via the fabric card and connected busses;
transferring packets from the second service card to the second line card via the fabric card and connected busses.

41. The process according to claim 40, further comprising:
transferring packets from the second line card to the second service card via the fabric card and connected busses;
transferring packets from the second service card to the first service card via the fabric card and connected busses;
transferring packets from the first service card to the first line card via the fabric card and connected busses.

42. A network gateway process according to claim 25, further comprising
providing a switch fabric;
connecting a first line card to the switch fabric via a bus, the first line card providing a network interface;
connecting a first service card to the switch fabric via a bus
connecting a second line card to the switch fabric via a bus, the second line card providing a network interface;
connecting a second service card to the switch fabric via a bus;
transferring packets from the first line card to the first service card;
processing packets at the first service card including one or more of de-encapsulation and decryption as part of said step of said step of ingress processing of packets;
transferring packets from the first service card to the second service card;
processing packets at the second service card including one or more of encapsulation and encryption as part of said step of egress processing packets;
transferring packets from the second service card to the second line card.

43. A process according to claim 42, wherein each of said first service card and said second service card process ingress packets from a line card, including encapsulation and encryption processing separate from processing egress packets to a line card, including de-encapsulation and decryption with separate processing subsystems.

44. The process according to claim 29, further comprising:
segregating traffic including physical segregating data traffic using one or more service card and one or more line card with traffic flows segregated from data traffic on one or more other service card and one or more other line card.
